(19) United States
(12) Patent Application Publication
(10) Pub. No.: US 2018/0229683 A1
(43) Pub. Date: Aug. 16, 2018

(54) MULTILAYER AIRBAG

(71) Applicant: Kiomars Anvari, Walnut Creek, CA (US)

(72) Inventor: Kiomars Anvari, Walnut Creek, CA (US)

(21) Appl. No.: 15/861,589

(22) Filed: Jan. 3, 2018

Related U.S. Application Data
(63) Continuation of application No. 62/458,626, filed on Feb. 14, 2017.

(51) Int. Cl. B60R 21/233; B60R 21/268; B60R 21/013

(52) U.S. Cl. CPC B60R 21/233; B60R 2021/23107; B60R 21/013; B60R 21/268

(57) ABSTRACT

A multilayer airbag for a protection system. The multilayer airbag consists of a number of independent airbags within one another which will be inflated with a time sequence or simultaneously.

The application claims priority to the following related applications and included here is as a reference.

Provisional application: U.S. patent application No. 62/458,626 filed Feb. 14, 2017, and entitled “PROTECTION GEAR FOR FLYING OBJECTS”.

Provisional application: U.S. patent application No. 62/470,523 filed Mar. 13, 2017, and entitled “EXTERNAL PROTECTION FOR MOVING VEHICLES”.

### BACKGROUND

Smart environments represent the next evolutionary development step in transportation systems automation. Like any sentient organism, the smart environment relies first and foremost on sensory data from the real world. Sensory data comes from multiple sensors of different modalities in distributed locations. The smart environment needs information about its surroundings as well as about its internal workings to activate devices that provide safety. One of these devices that are being used today is airbag. Airbags have evolved with regards to design, fabric and the components that go into making it.

The airbag specified for automobile use traces its origins to air-filled bladders as early as 1941. The invention is also credited independently to the German engineer Walter Linderer, and to the American John W. Hetrick who in 1951 registered for the first of his airbag patents. Linderer filed German patent #896,312 on 6 Oct. 1951, which was issued on 12 Nov. 1953, approximately three months after American John Hetrick was issued U.S. Pat. No. #2,649,311 on 18 Aug. 1953. Linderer's airbag was based on a compressed air system, either released by bumper contact or by the driver. Later research during the 1960s showed that compressed air could not inflate Linderer's airbag fast enough for maximum safety, thus making it an impractical system.

Hetrick was an industrial engineer and member of the United States Navy. His airbag was designed based on his experiences with compressed air from torpedoes during his service in the Navy, combined with a desire to provide protection for his family in their automobile during accidents. Hetrick worked with the major American automobile corporations at the time, but they chose not to invest in it. Although airbags are now required in every automobile sold in the United States, Hetrick's 1951 patent filing serves as an example of a “valuable” invention with little economic value to its inventor because its first commercial use did not occur until after the patent expired when in 1971, it was installed as an experiment in a few Ford cars.

In Japan, Yasuzaburou Kobori started developing an airbag “safety net” system in 1964, for which he was later awarded patents in 14 countries. He died in 1975 without seeing widespread adoption of airbag systems

In 1967, a breakthrough occurred in the development of airbag crash sensors when Allen K. Breed invented a mechanically-based ball-in-tube component for crash detection, an electromechanical sensor with a steel ball attached to a tube by a magnet that would inflate an airbag in under 30 milliseconds. A small explosion of sodium azide instead of compressed air was used for the first time during inflation. Breed Corporation then marketed this innovation first to Chrysler. A similar “Auto-Ceptor” crash-restraint, developed by the Eaton, Yale & Towne company for Ford was soon offered as an automatic safety system in the United States, while the Italian Eaton-Livia company offered a variant with localized air cushions.

An airbag is made up of three parts. The first part is the bag itself that is made out of thin nylon fabric and is folded in the steering wheel or the dashboard of a car. The second part of the airbag is the sensor that informs the bag to inflate when the car meets with an accident. The sensor detects the collision force and calculates the force equal to running into a brick wall at around 10 to 15 miles per hour. The third part consists of an inflation system.

The airbags are inflated using sodium azide and potassium nitrate. When any collision takes place, the sensor detects the collision force and informs the bag to inflate. At that time, the sodium azide and potassium nitrate react quickly and produces a large pulse of hot nitrogen gas. The gas inflates the bag in turn and the bag literally bursts out of the steering wheel or the dash board. After a second, the bag starts deflating with the help of the holes present on it to get out of your way.

This patent application discloses a multilayer airbag for protection system. The multilayer airbag consists of a number of independent airbags within one another which will be inflated with a time sequence or simultaneously. The multilayer airbag can be a component of a protection system used for various application such as automobiles, motorcycles, bicycles, robots, body armors, drones, flying cars, any flying objects, and any moving objects.

### BRIEF DESCRIPTION OF THE DRAWINGS

FIG. 1 shows a multilayer airbag system

FIG. 2 shows an embodiment of a plurality of inflators

FIG. 3 illustrates an embodiment of a single inflator

FIG. 4 depicts an embodiment of a method for using a multilayer airbag protection gear

The drawings referred to in this description should be understood as not being drawn to scale except if specifically noted.

### DESCRIPTION OF EMBODIMENTS

Reference will now be made in detail to embodiments of the present technology, examples of which are illustrated in the accompanying drawings. While the technology will be described in conjunction with various embodiment(s), it will be understood that they are not intended to limit the present technology to these embodiments. On the contrary, the present technology is intended to cover alternatives, modifications and equivalents, which may be included within the spirit and scope of the various embodiments as defined by the appended claims.

Furthermore, in the following description of embodiments, numerous specific details are set forth in order to provide a thorough understanding of the present technology. However, the present technology may be practiced without these specific details. In other instances, well known methods, procedures, components, and circuits have not been described in detail as not to unnecessarily obscure aspects of the present embodiments.

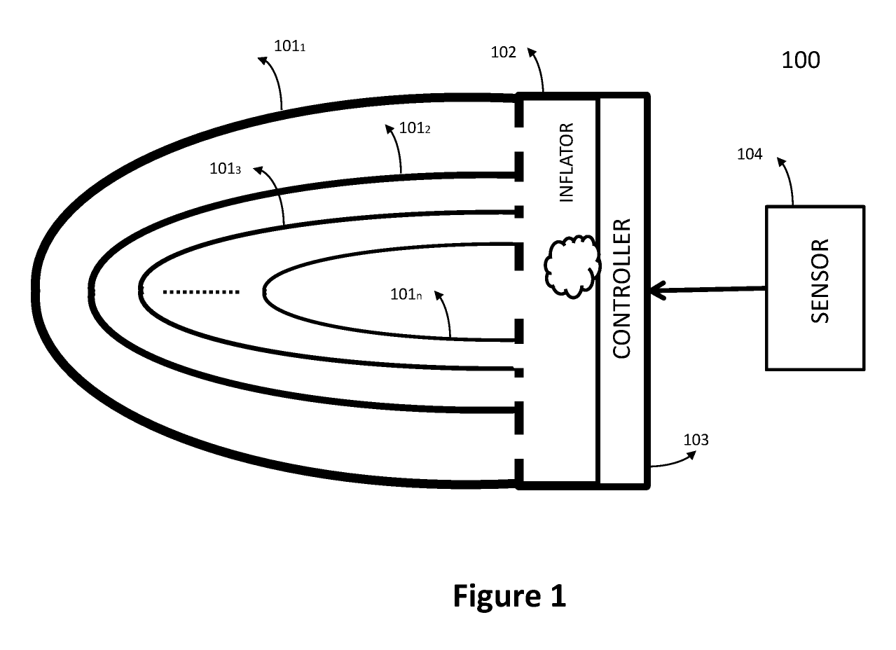

FIG. 1 illustrates an embodiment of a multilayer airbag protection system 100. In general, the multilayer airbag protection system 100 provides protection by inflating “n” airbags that are within one another. When sensor 104 detects an approaching object to the multilayer airbag protection system, it sends a detection information data to the controller 103. The controller 103 based on the detection information data and other available data decides to activate the inflator 102 to inflate airbags 101₁ to 101ₙ.

Multilayer airbag protection system 100 includes, among other things, sensor 104, controller 103, inflator 102, and “n” airbags 101₁ to 101ₙ that are within each other.

In one embodiment, the sensor 104 can be at least one of image sensor, wireless sensor (radar), heat sensor, speed sensor, acceleration sensor, ultrasonic sensor, proximity sensor, pressure sensor, G sensor, and IR (infrared) sensor.

In one embodiment of multilayer airbag protection system 100, the controller 103 provides the firing driver for the inflator 102 gas generator, monitors operation of the multilayer airbag, and indicates any malfunction.

In one embodiment of multilayer airbag system 100, the inflator 102 inflates multilayer airbag 101₁ to 101ₙ based on the activation it receives from controller 103 by producing a large pulse of hot nitrogen gas.

In one embodiment of multilayer airbag, the airbag 101₂ resides inside airbag 101₁, the airbag 101₃ resides inside airbag 101₂, and ultimately airbag 101ₙ resides inside airbag 101ₙ₋₁.

In one embodiment of multilayer airbag, the airbag 101₂ inflates within airbag 101₁, the airbag 101₃ inflates within airbag 101₂, and ultimately airbag 101ₙ inflates within airbag 101ₙ₋₁.

In one embodiment, the multilayer airbag 101₁ to 101ₙ provide “n” layer of redundancy.

In one embodiment of multilayer airbag 100, the controller 103 activates the inflator 102 based on at least one of the information it receives from the sensor 104, the central brain or artificial intelligence (AI) of the equipment or gear that uses multilayer airbag 100, and other entities (for example an operating person).

In one embodiment of multilayer airbag 100, the controller 103 acts as the main brain or artificial intelligence and activate the inflator 102 based on the information it receives from the sensor 104 and other sensors of the equipment or gear that uses multilayer airbag 100.

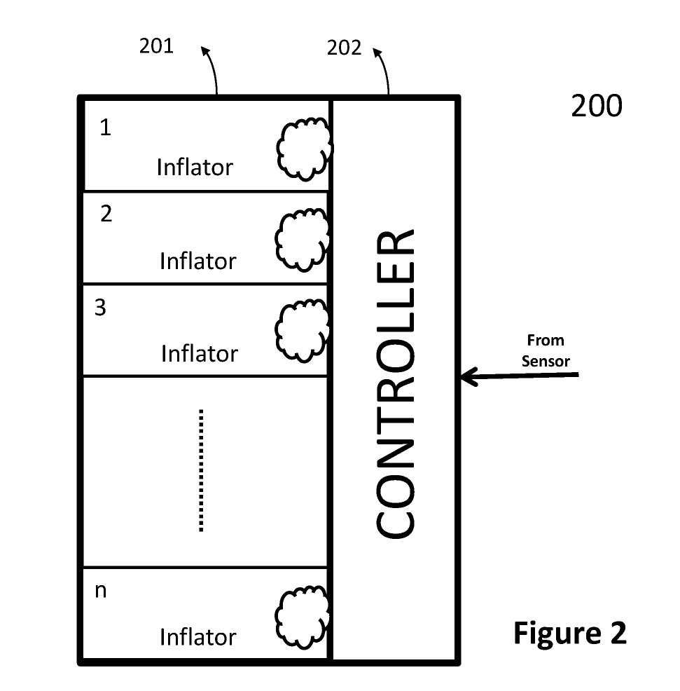

FIG. 2 depicts an embodiment of multilayer airbag inflator system 200. In general the inflator system 200 inflates “n” airbags independently.

The airbag inflator system 200 includes, among other things, controller 202, and inflator 201.

In one embodiment of inflator system 200, the inflator 201 consists of “n” independent inflator each assigned to one of the airbags within multilayer airbag 101₁ to 101ₙ.

In one embodiment of inflator system 200, the controller 202 activates the “n” inflators of the inflator 201 simultaneously.

In another embodiment of inflator system 200, the controller 202 activates the “n” inflators of inflator 201 with a defined time sequence.

In another embodiment of inflator system 200, the controller 202 activates a subset of “n” inflators of inflator 201 either simultaneously or with a defined time sequence based on predefined configuration parameters stored in controller 202.

In another embodiment of inflator system 200, the controller 202 receives the activation information data from sensor 104 and other entities.

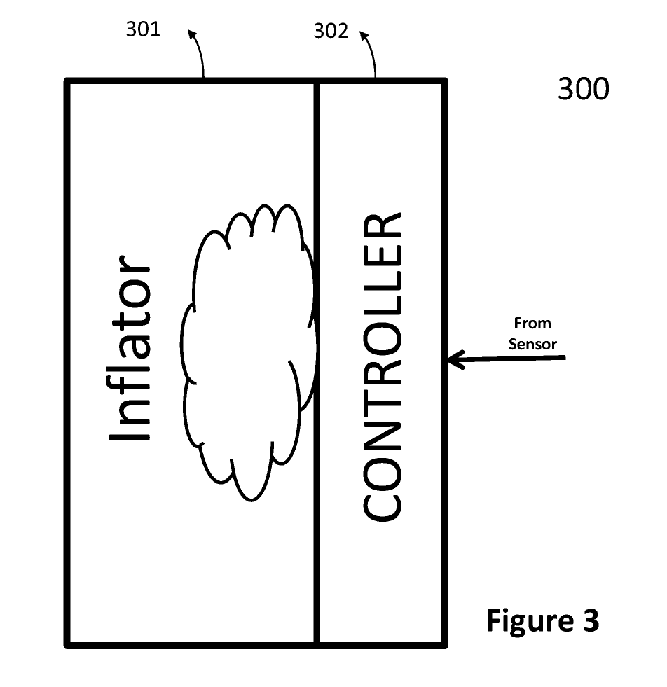

FIG. 3 depicts an embodiment of multilayer airbag inflator system 300. In general the inflator system 300 inflates “n” airbags of multilayer airbags 101₁ to 101ₙ.

The airbag inflator system 300 includes, among other things, controller 302, and inflator 301.

In one embodiment of multilayer airbag inflator system 300, the inflator 301 consists of one inflator for all airbags of multilayer airbag 101₁ to 101ₙ.

In one embodiment of multilayer airbag inflator system 300, the controller 302 activates inflator 301 and multilayer airbag 101₁ to 101ₙ are inflated simultaneously or sequentially.

In one embodiment of multilayer airbag inflator system 300, the airbags 101₁ to 101ₙ each have its own independent valve, and the valves are opened at the same time or sequentially by controller 302.

In one embodiment of multilayer airbag inflator system 300, the controller 302 activates inflator 301 but only a subset of multilayer airbags 101₁ to 101ₙ are allowed to inflate by opening a subset if valves based on predefined configuration parameters stored in controller 302.

In one embodiment of multilayer airbag inflator system 300, the inflator 301 provides controlled amount of gas for each airbag within the multilayer airbags 101₁ to 101ₙ by opening the airbag valves at an appropriate time.

In one embodiment of multilayer airbag inflator system 300, when the inflator 301 simultaneously inflates the multilayer airbags 101₁ to 101ₙ the valve of each airbag opens on a timely manner to receive the needed gas from the inflator 301.

In another embodiment of inflator system 300, the controller 302 receives the activation trigger from sensor 104 and other entities (for example an operator).

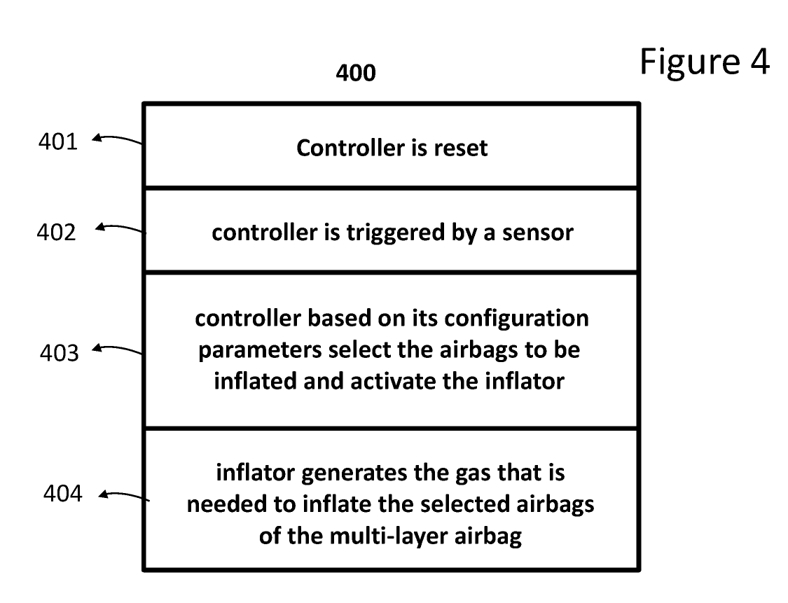

FIG. 4 depicts an embodiment of method 400 for using a multilayer airbag protection gear. In various embodiments, method 400 is carried out by sensor, inflator, multilayer airbag and controller under the control of processes or executable instructions. The readable and executable instructions reside, for example, in a data storage medium such as processor usable volatile and non-volatile memory. However, the readable and executable instructions may reside in any type of processor readable storage medium. In some embodiments, method 400 is performed at least by one of the circuits described herein.

At 401 of method 400, the controller is reset.

At 402 of method 400, the controller is triggered by a sensor or an operator.

At 403 of method 400, the controller based on its configuration parameters selects the airbags to be inflated and activate the inflator.

At 404 of method 400, the inflator generates the gas that is needed to inflate the selected airbags of the multilayer airbag.

Various embodiments are thus described. While particular embodiments have been described, it should be appreciated that the embodiments should not be construed as limited by such description, but rather construed according to the following claims.

1. A multilayer airbag for a protection system comprising:
a plurality of airbags that support a first outer airbag, a second inner airbag inside the first outer airbag, a third inner airbag inside the second inner airbag, a fourth inner airbag inside the third inner airbag, a fifth inner airbag inside the fourth inner airbag and so on;
an inflator to inflate the plurality of airbags;
a sensor to detect at least one of an impact, an approaching object, a fall and send a detected information data to a controller;
said controller processes at least one of the detected information data received from the sensors and other entities to decide to activate the inflator.

2. The multilayer airbag of claim 1, wherein the protection system is used for at least one of moving objects and falling objects.

3. The multilayer airbag of claim 1, wherein the inflator uses a single chemical reaction to inflate the multilayer airbag.

4. The multilayer airbag of claim 1, wherein an airbag in the multilayer airbag has an independent valve.

5. The multilayer airbag of claim 1, wherein the inflator provides controlled amount of gas for the airbag within the plurality of airbags by opening the airbag valve at an appropriate time.

6. The multilayer airbag of claim 1, wherein the controller opens a subset of the valves based on a predefined configuration to inflate a subset of airbags in the multilayer airbag.

7. The multilayer airbag of claim 1, wherein the controller acts as an artificial intelligence to activate the inflator based on the information data received from the sensors and other entities.

8. The multilayer airbag of claim 1, wherein the sensor is at least one of image sensor, wireless sensor (radar), heat sensor, speed sensor, acceleration sensor, ultrasonic sensor, proximity sensor, pressure sensor, G sensor, and IR (infrared) sensor.

9. The multilayer airbag of claim 1, wherein the controller is an artificial intelligence for an equipment/device operation system using the multilayer airbag protection system.

10. A multilayer airbag comprising:
a plurality of airbags that support a first outer airbag, a second inner airbag inside the first outer airbag, a third inner airbag inside the second inner airbag, a fourth inner airbag inside the third inner airbag, a fifth inner airbag inside the fourth inner airbag and so on;
a plurality of inflators to inflate the plurality of airbags;
a sensor to detect at least one of an impact, an approaching object, a fall and send a detected information data to a controller;
said controller processes at least one of the detected information received from the sensors and information from other entities to decide to activate the plurality of inflators based on a predefined configuration.

11. The multilayer airbag for a protection gear and equipment claim 10, wherein an airbag within the plurality of airbags has an independent inflator.

12. The multilayer airbag for a protection gear and equipment claim 10, wherein said independent inflator uses an independent chemical reaction to inflate said airbag.

13. The multilayer airbag for a protection gear and equipment claim 10, wherein the controller activates the independent inflators of the plurality of airbags simultaneously.

14. The multilayer airbag for a protection gear and equipment claim 10, wherein the controller activates the independent inflators of the plurality of airbags with a time sequence based on said predefined configuration stored in the controller.

15. The multilayer airbag for a protection gear and equipment claim 10, wherein the controller activates a subset of the inflators to inflate a subset of said airbags in the multilayer airbags simultaneously.

16. The multilayer airbag for a protection gear and equipment claim 10, wherein the controller activates a subset of the inflators to inflate a subset of said airbags in the multilayer airbags with a time sequence based on the predefined configuration stored in the controller.

17. The multilayer airbag for a protection gear and equipment claim 10, wherein the controller acts as an artificial intelligence to activate the inflator based on the information data received from the sensors and other entities.
